(19) United States
(12) Patent Application Publication
(10) Pub. No.: US 2001/0050690 A1
(43) Pub. Date: Dec. 13, 2001

(54) Image transfer matrix

(76) Inventors: Conley Wilson Giles, Georgetown, TX (US); Thomas Alan Gindrup JR., Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/784,395

(22) Filed: Feb. 15, 2001

Related U.S. Application Data
(60) Provisional application No. 60/182,701, filed on Feb. 15, 2000.
(60) Provisional application No. 60/157,173, filed on Sep. 30, 1999.
(60) Provisional application No. 60/177,868, filed on Jan. 24, 2000.

(51) Int. Cl. G09G 5/00

(52) U.S. Cl. 345/636

(57) ABSTRACT

A user can use a system to automatically generate composite images to display how a marking may appear on an item more quickly compared to conventional methods. A data processing system using a data processing system readable medium may perform much of the process needed to generate the composite images. Transforming an image of a marking, mapping that image over an image of an item, and displaying the composite image or portions of those acts can be performed by the data processing system to reduce manual operations otherwise performed by a human. In one embodiment, from a user's perspective, a user may instruct the data processing system which marking(s) to use, and the data processing system does the rest of the operation through displaying composite images. In another embodiment, a scanner can be used to scan a document and farther automate the process.

### RELATED APPLICATIONS

This application claims priority under 35 U.S.C. §119(e) to U.S. patent application Ser. No. 60/182,701 entitled “Image Transfer Matrix” by Giles filed Feb. 15, 2000. This application is related to U.S. patent application Ser. No. 09/688,711 entitled “Methods of Providing and Obtaining Information, Items, Orders, and Digital Representations and Using Electronic Communication Systems” by Giles et al. filed Sep. 27, 2000, which is a non-provisional patent application of U.S. patent application Ser. Nos. 60/157,173 entitled “Online Promotional System and Method” by Passino et al. filed Sep. 30, 1999, and 60/177,868 entitled “Online Promotional System and Business Method” by Giles et al. filed Jan. 24, 2000. All applications listed in this paragraph and are assigned to the current assignee hereof and are incorporated herein by reference.

### FIELD OF THE INVENTION

This invention relates in general to methods and data processing system readable media, and more particularly, to methods and data processing system readable related to at least partially automated image placement when generating a composite image.

### RELATED ART

Within the promotional products industry, the ability of illustrating markings on items, such as blanks (unmarked products), is important. Currently, artwork can be manually generated and sent to a person dealing with promotional products. A graphics artist or other similar person would create a template of the image as shown in the artwork to create transferable artwork that would be used to transfer the artwork onto the blank product. One problem with this type of situation is that it is expensive to make one sample just to examine how the marking will actually appear on the product. To avoid this expense, the user may envision what the logo would look like on the product; however, this may not accurately represent the actual product with the marking.

Computers may be used in creating images of how the markings would appear on the items. However, the process is principally a manual process. For example, a customer may have a file with an image of a logo and access to a file with an image of the product. Next, the customer would manipulate the logo onto the product to appear the way the customer would like to see it. Clearly, the method has a number of problems. First, human interfacing is needed for each combination of product and marking. When there are numerous markings or products, the process is very time consuming. Second, the image of the logo on the item may be different compared to the actual item with the logo. Typically, the customer has to assume the entire risk for the order and may end up with a large inventory of unusable promotional products. Third, the customer may try to place the marking in a location, which unknown to the customer, is a location where the marking cannot be placed (e.g., too close to an edge, along a surface where the marking cannot be made, beyond the limits of the equipment used by a supplier to place or transfer the marking onto the items, or the like).

### SUMMARY OF THE INVENTION

A user can have composite images of physical items (i.e., items), such as promotional products, and markings, such as logos, pictures, or other similar representations, generated relatively quickly and automatically to allow a user to examine and review images that more closely represent the way physical objects would appear if the user's marking was to be transferred to the physical objects. The manual processes previously described can be improved upon by the more automated system of generating composite images that can be performed by a data processing system(s) as discussed herein.

The present invention includes many different embodiments. In a first set of embodiments, a method can be used to automatically place an image of a marking over an image of an item. The method can comprise accessing the image of the marking and the image of the item. The image of the item can include a marking area. The method can also comprise mapping the image of the marking over the image of the item. The image of marking may be mapped so that it lies at least partially within the marking area. Mapping may includes an act of positioning the image of the marking and the image of the item with respect to each other or pasting the image of the marking and the image of the item together. The act can be performed without any human intervention (i.e., automatically by a data processing system and software code).

In a second set of embodiments, a method can be used to automatically place an image of a marking over an image of an item. The method can comprise accessing the image of the marking and the image of the item. The image of the item can include a marking area. The method can also comprise transforming the image of the marking and mapping the image of the marking onto the image of the item. Transforming may include an act of changing a size of the image of the first marking, skewing at least a portion the image of the first marking, rotating at least a portion of the image of the first marking, or changing a shape of at least a portion of the image of the first marking. The act can be performed without any human intervention.

In a third set of embodiments, a method can be performed for a user to automatically receive at least one composite image while at an electronic site. The method can comprise performing an act that is performed by the user. The act can be sending an image of a marking associated with the user to a first entity, selecting the image of the marking associated with the user, or selecting an identifier for a second entity associated with the user, wherein the identifier is associated with the image. After performing the act, the method can also comprise receiving the composite image by the user from the first entity. The composite image may include the marking and an item.

In a fourth set of embodiments, a method can be used to place an image of a marking over an image of an item. The method can comprise scanning a document (e.g., a business card, a letterhead, or the like) using a scanner and automatically extracting the image of the marking and at least some information from the document (e.g., contact information). The method can also include automatically placing the image of the marking over the image of the item to create a composite image. The method can further include displaying the composite image to a user. The method may include automatically entering the information into at least one information field.

Many of the methods may be done may be performed wholly or in part using a data processing system that has access to a data processing system readable medium. The data processing system readable medium can have a code that may include instructions executable by a data processing system to perform at least some of the methods described herein.

### BRIEF DESCRIPTION OF THE DRAWINGS

The present invention is illustrated by way of example and not limitation in the accompanying figures, in which like references indicate similar elements, and in which:

FIG. 1 includes an illustration of a system configuration for use in an embodiment of the present invention;

FIG. 2 includes an illustration of a more detailed view of a portion of the system configuration of FIG. 1;

FIG. 3 includes an illustration showing relationships between data structures;

FIG. 4 includes an illustration of a view of a user interface displaying promotional items available to a user;

FIG. 5 includes a process flow diagram for placing a marking or markings over images of products using an embodiment described herein;

FIGS. 6-8 include illustrations of views of a user interface displaying markings and some options available to a user; and

FIG. 9 includes an illustration of a view of a user interface displaying composite images of images of items and images of markings selected by a user.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A method or data processing system program or a data processing system readable medium can be used for automatically placing an image of a marking over an image of an item or for a user to automatically receive a composite image of the marking and the item. In some embodiments, files including the images of the marking and item can be provided by various sources or accessed from a database. The composite images can be generated by transforming an image of a marking and mapping the image of the marking over an image of an item. The composite images may be received by the user more quickly than in conventional methods because the transforming or mapping operations, or portions of them, can be performed by a data processing system without any human intervention. The present invention is defined by the appended claims and is better understood after reading the description of embodiments that follow.

Before describing the embodiments in more detail, some terms used herein are defined or clarified to improve understanding. “Entity” is any individual, partnership, company, corporation, organization, or group of individuals. “Information” should be broadly interpreted and may include an inquiry, a request, data, or the like. “Electronic site” includes any site where information is sent in response to electronic or optical signal(s) received by a communication device, such as a computer, mobile phone, personal digital assistant, or the like. A web site is an example of a common type of electronic site. Electronic site is not meant to include a conventional fax machine. Clearly, other activities can be performed at the electronic site. A “data processing system” includes a computer, microprocessor, microcontroller, or the like and any associated software or firmware. A “marking” includes a company name, a trademark, a logo, a slogan, a phrase, a sentence, a picture of a person, a pet or a location, a family crest, a monogram, a map of a city, state, country or other geographic region, or the like. From the user's perspective, the user's marking can be a marking that the user created, a marking of the user's employer, company, or the like, or a marking otherwise associated with the user.

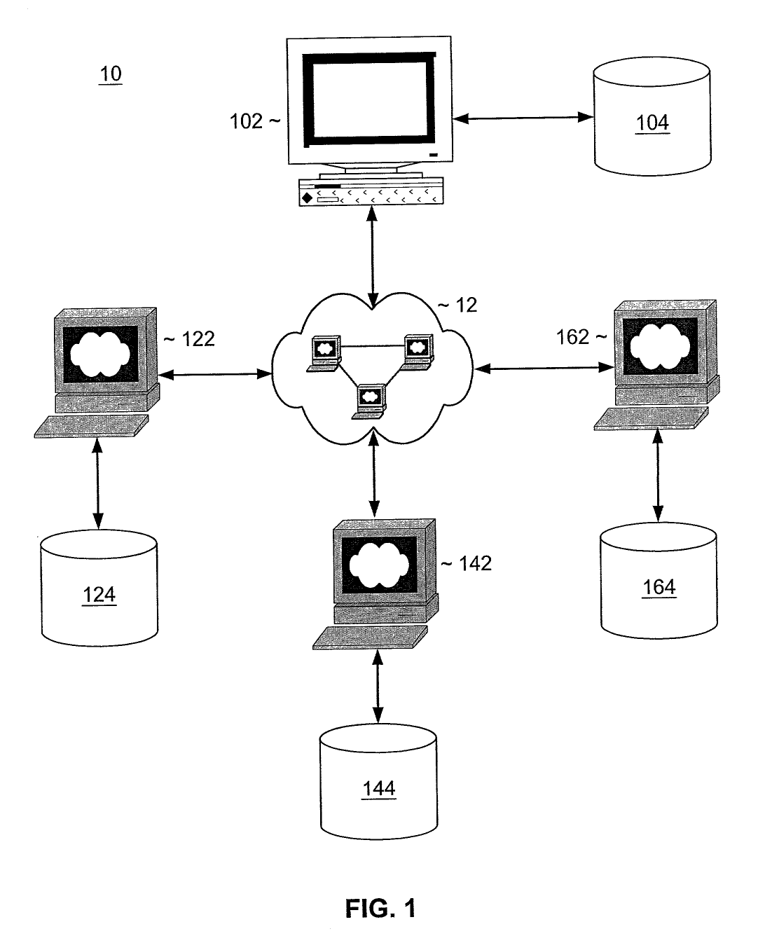

FIG. 1 includes an illustration of a communication system 10 that may be used in an embodiment of the present invention. A client 102 is bi-directionally coupled to a storage device 104 and a network 12. In one specific embodiment, the client 102 may represent a user (a human) that is using a personal computer, and the network 12 can be the Internet. Although not shown, an electronic site access provider (e.g., Internet service provider) may lie between and be bi-directionally coupled to the client 102 and the network 12. FIG. 1 further includes servers 122, 142, and 162, which are bi-directionally coupled to the network 12. Any or all of the servers 122, 142, and 162 may control at least one electronic site. Each of the servers 122, 142, and 162 are bi-directionally coupled to their respective storage devices 124, 144, and 164.

Each of the client 102 and servers 122, 142, or 162 may operate using a Windows, MacOS, OS/2, Linux, Unix or other similar operating system. Client 102 may include a personal computer that may operate using a personal computer version of any those operating systems. The server 122, 142, or 162 may operate using a server version of any of those operating systems.

Each of the client 102 and servers 122, 142, and 162 can include a data processing system and a random access memory (RAM), which includes a data processing system readable medium. All of the storage devices 104, 124, 144, and 164 can include a data processing system readable medium. As shown, any of client 102, server 122, 142, or 162 can include software code that may be executed by a processor within the client 102, or server 122, 142, or 162 as a set of data processing system-executable instructions for carrying out at least some of the methods described in more detail later in this specification. The code may reside, for example, in RAM of the client 102 or server 122, 142, or 162. Alternatively, the code may be contained on storage device 104, 124, 144, or 164 embodied within a different data processing system readable medium, such as a computer diskette, a CD ROM, or the like. Alternatively, the code may be embodied within a magnetic tape, conventional hard disk drive, electronic read-only memory, optical storage device, or other appropriate data storage device.

The client 102 and servers 122, 142, and 162 may communicate to each other using electronic or optical signals. Humans can communicate with the client 102 or any of the servers 122, 142, or 162, however, communications from humans may be converted to electronic or optical signals and communications from the client 102 or any of servers 122, 142, or 162 may convert electronic or optical signals to a human-understandable form, such as displaying information on the client's monitor.

FIG. 1 includes one specific example illustrating one hardware configuration for using an embodiment of the present invention. The user at client 102 may be interested in getting information related to promotional products (e.g., hats, pens, key chains, mugs, etc. that include promotional logos, text, or other markings on the products). Server 122 and storage device 124 may be used by a distributor of the promotional products, server 162 and storage device 164 may be used by a supplier of the promotional products, and server 142 and storage device 144 may be used by an intermediary party between any two or more of the user, the distributor, and the supplier.

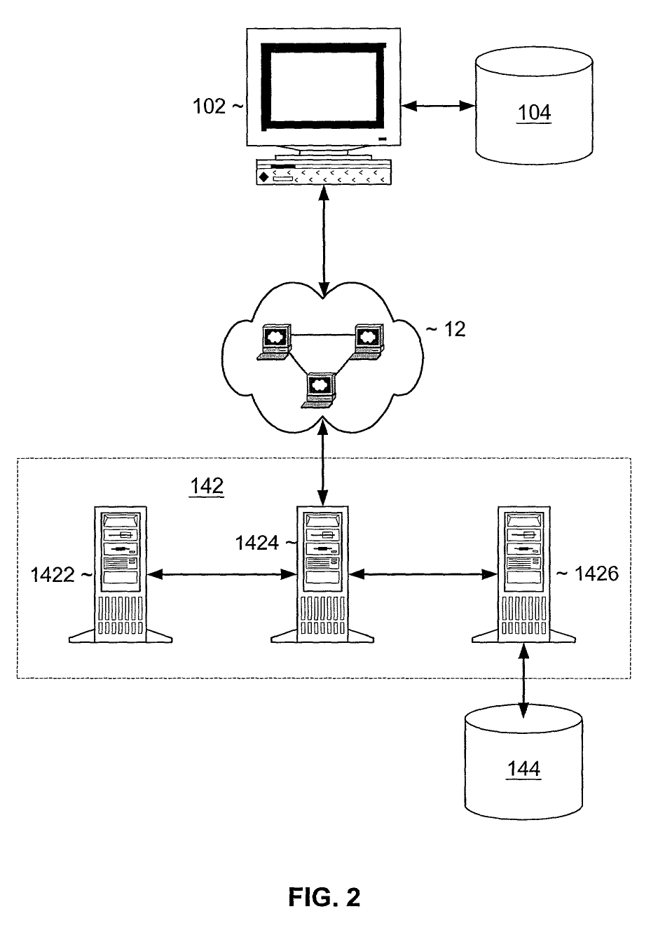

In one specific, non-limiting embodiment, the client 102 may interact with server 142 using the network 12 as shown in FIG. 2. Storage device 104 may include a repository of files including files having images of markings and composite images previously received from server 142. The server 142 may include a combination of separate servers 1422, 1424, and 1426. Server 1422 may be a content management server for an electronic site. Server 1424 may be a page generator server and is bi-directionally coupled to the servers 1422 and 1426 and the network (e.g., Internet) 12. Server 1424 may support Active Server Pages (ASP), Java Server Pages (JSP), or the like. Server 1426 can be an object or database manager server that is bi-directionally coupled to the storage device 144. Server 1426 and storage device 144 may include information and images for markings (logos, pictures, text, and the like) and items (e.g., blanks for promotional products and other physical items). Server 1424 may generate pages (views) for the electronic site that are sent to the user at client 102, where the pages include information from any or all of the servers 1422, 1424, 1426, and client 102. For example, client 102 may request a page from an electronic site supported by server 1424. In response to the request, server 1424 may take page template information from the server 1422 and images and data from server 1426 to generate a page that is sent to client 102.

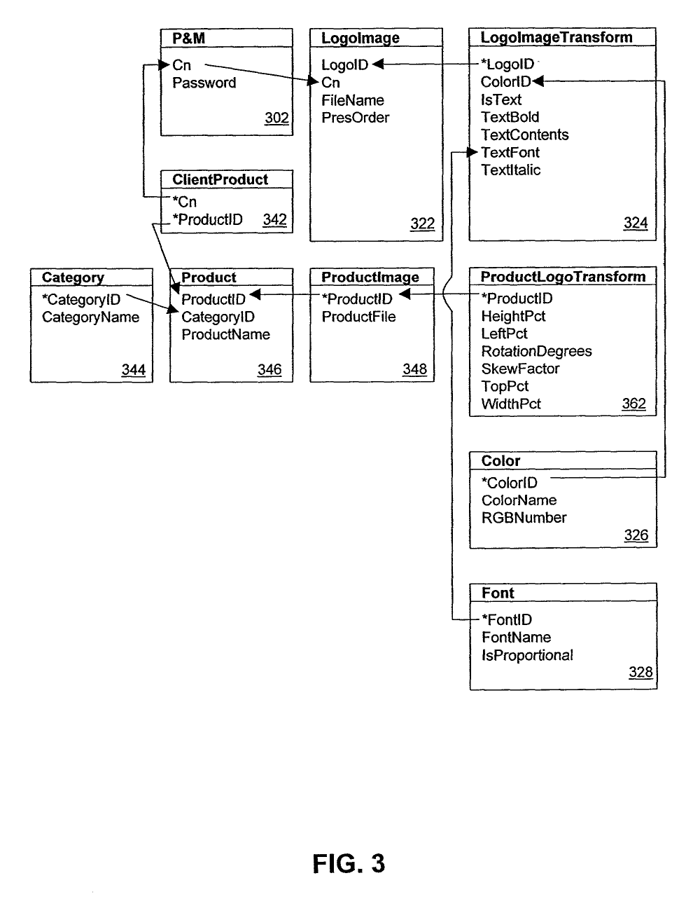

Before turning to methods of using the system 10, data structures and object specifications are described. Some, all, or additional data structures and object specifications can be used in different embodiments. The relationships between the data structures are illustrated in FIG. 3.

The Personalization and Membership (P&M) table 302: Each record in the P&M table 302 can contain a customer (user or user's entity) name, number or other identifier (“customer name” or “Cn”) and a password.

Logo Image table 322: Each record in the Logo Image table 322 may include a marking identifier (“LogoID”), Cn, a file name for the image of the marking (FileName), and a precedential order (used if more than one logo is within the file for a specific user).

Logo Image Transform table 324: Each record in Logo Image Transform table 324 can include a pointer to the marking identifier (“*LogoID”), a color identifier (“ColorID”), whether text is present (“IsText”), whether text is boldfaced (“TextBold”), the text itself (“TextContents”), the font for the text (TextFont”), and whether the text is italicized (“TextItalic”). The logo identifier is linked to the logo identifier within the Logo Image data.

Color table 326: Each record in the Color table 326 can contain a pointer to the color identifier (“*ColorID”), a color display name (“ColorName”), and a color value (Red-Green-Blue Number or “RGB Number”).

Font table 328: Each record in Font table 328 can have a pointer for a font identifier (“*FontID”), a font name (“FontName”), and whether the text is to be displayed proportionally (“Is Proportional”).

Client Product table 342: Each record in the Client Product table 342 can include pointers to Cn (“*Cn”) and the product identifier (“*ProductID”).

Category table 344: Each record in the Category table 344 can have a pointer to a category identifier (*CategoryID) and a category name (CategoryName).

Product table 346: Each record in the Product table 346 can include a product indentifier (“ProductID”), a category identifier (“CategoryID”), and a product name to be displayed at client 102 (“Product Name”).

Product Image table 348: Each record in the Product Image table 348 can include a pointer to the product identifier (*ProductID), and a file that includes an image of an item (“ProductFile”). This may be referred to as “clean product images”.

Product-Logo Transform table 362: Each record in the Product-Logo table 362 can contain a pointer to a product identifier (*ProductID), height of the marking as a percentage of the total height of the item (“HeightPct”), distance that a closest point of the marking is to the left-hand side of the item as a percentage of the total width of the item (“LeftPct”), rotation (in degrees) of the marking with respect to the item (“RotationDegrees”), skew factor, which is related to depth information (“SkewFactor”), distance that a closest point of the marking is to the top of the item as a percentage of the total height of the item (“TopPct”), width of the marking as a percentage of the total width of the item (“WidthPct”).

The following data structures may be used but are not shown in FIG. 3.

Company Folder table: A user or user's entity (e.g., a company) may a plurality of logos or other markings that may be used. Each record in the table may include pointers to Cn and LogoID.

Template-product table: Each tuple within the table may include a template identifier and pointer(s) to product identifier(s). The product template table can be used to determine which item or items may be used in composite images to be generated.

Other template tables. Corresponding template tables can be used that are similar to the category table 342, the product image table 346, and the product-logo transform table 348. The records for these template tables may include substantially the same types of information as their corresponding tables in FIG. 3 and may include additional information related to a template identifier.

Client/Product resolution table: Each record may contain pointer to a Cn and product identifier(s) for item(s) that are to be used as part of the composite image(s) to be displayed at the client 102.

Some information within the tables is described in more detail. Regarding the color identifier, the color can be an integer or long integer value depending on number of colors possible. Even larger data types can be used as the number of possible colors are increased. As an alternative, other identifiers can be used for the colors including a Pantone™ color number, wavelength of the color, a color numbering system based on a standards body, or the like.

The “IsText” variable may have a Boolean data type. If true, text can be used as at least part of the marking. The “IsProportional” variable may have a Boolean data type. If true, each character is displayed in proportion to the area it occupies rather than each character being allocated the same size of space regardless of the area occupied by the character (as is typically seen with conventional typewriters or using a courier-style font).

The product image table may include additional information. The folder can have a list of various image sizes (a list order) and the name of a different folder in which images of a particular size are stored. The list order may include the order that can be used when displaying different file sizes to the user. A product field image name can be used and include the name of the field in the Product Image table where the file name for the image of the particular size is stored.

The object manager server 1426 can be used in storing and retrieving data or other information within a database in storage device 144. Some or even all the information with respect to the tables may be included within the database. In addition to the tables and variables previously described, control information may be kept within the storage device 144. The control information may include an absolute file name, a relative file name, a root path information, base path information, a time stamp, or any combination of them. The control information may be in the form of a text file.

Client 102 and servers 122, 1422, 1424, 1426, and 164 may use absolute and relative file names. An absolute file name can include all information for a file starting at the root level. A relative file name can be shorter and typically does not go to the root level. For example, a file having a name “text.doc” may have an absolute file name of “D:\User\Data\Word\text.doc” and a relative file name of “Word\text.doc” or “Data\Word\text.doc”. The relative file name is typically a shortened version of the absolute file name. Note that the absolute and relative file names may be specific to a machine.

For network connections, such as network 12, a file may be specified using a root path or a base path. The root path is similar to absolute file name. With a network, a server may need to go to a different data processing system to find the file. An example of a root path may include

“www.promoorder.com/product/images/jpg/pens.jpg” and the base path may include “www.promoorder.com/products/images/” or

“www.promoorder.com/products/images/jpg” or the like. For the root path, the server may go to promoorder.com web site search for a folder entitled “product”, search for a folder entitled “images” within the product folder, search for a folder entitled “jpg” within the images folder, and search for a file entitled “pens.jpg” within the jpg folder. The base path may be thought of as a “complement” to the relative file name. The base path is directed to a folder rather than a file. For the root path above, the base path could end at the product folder, the images folder, or the jpg folder. For a single file, an absolute file name or root path may be derived from a combination of the base path and the relative file name for that single file.

Transferring data-intensive files consumes limited resources of the system 10. Therefore, reducing transfers of these files may be desirable. The control information can be used to help reduce transmission of data-intensive files, such as graphics files that include an image of a marking or an image of an item. When the user at client 102 accesses an image file, the user may specify a file name using an absolute or relative file name. The server 142 may access a database at storage device 144 to obtain the control information to determine if the database at storage device 144 already has the image file. If the control information for the image file corresponds to the file name received from client 102, the database has the image file and it does not need to be transferred. If the control information for the image file does not correspond to the file name received from client 102, the server 142 may not have the image file. The server 142 may request the client 102 for the image file. The process may be configured in a similar manner when the server 122, 142, or 162 is sending information to the client 102 or when used between servers 122, 142, or 166.

Object specifications (also called class definitions) may include some or all of the data structures already given and may include additional data structures or variables. A first variable for the original file name for the image of the marking may include the storage location of the file for the image of the marking that is currently in use. The information can be used to reset a currently used two-color selection to its original parameters or used as-is in a multi-color display. A second variable can be used for the current file name of the image of the marking that is currently in use, that is, in the format of the user's current preferences. This information may only include the file name. The path may be derived from other control information in the system 10. The information for the first and second variables may only correspond to the file name. The path to the files may be derived from other control information in the system 10.

The object specification may also include information related to attributes or specifications for marking areas, which are areas within items where markings may be placed. This information may include the size, shape, location, rotation, skewing information, or the like for the marking area.

A same or different object specification can include at least one method (also called a behavior or a function). The methods can include a creating a composite image, validating graphics files, other functions, or any combination thereof. The creating composite image method may be passed one or more variables including the file name for the image of the marking, an item images folder, a composite images folder, Cn, item identifier, and information regarding coloring for the marking. The information can include whether any portion of the marking is to be transparent, whether two colors are to be used for the marking and the two colors themselves, a foreground color for the marking, a background color for the marking (if any), a tolerance factor between the colors (as will be described later), or the like.

The validating graphics file method may be passed one or more variables including the file name of the marking or item, the file with the image of the marking or item, or the like. The validating graphics file method is performed to confirm that graphics files are acceptable. Details of the validation method are described later in this specification.

In the preceding paragraphs, many details have been given with respect to system configurations, data structures, object specifications, variables and the like. These details are meant to illustrate just some of the possible embodiments. Additional components, variables, or other system configurations data structures, object specifications, or the like may be used. Skilled artisans appreciate that such changes do not depart from the scope of the present invention.

Attention is now directed to using the system in order to obtain composite images that include an image of a marking and an image of an item. In one example, the method can be used for creating or modifying an electronic version of a company store. For example, the method can be used to generate and display composite images of a company's logo (an example of a marking) on promotional products (an example of items). Upon entering the site, the user may be asked for an identifier and a password using a conventional security technique. This information may be kept in the P&M table described above.

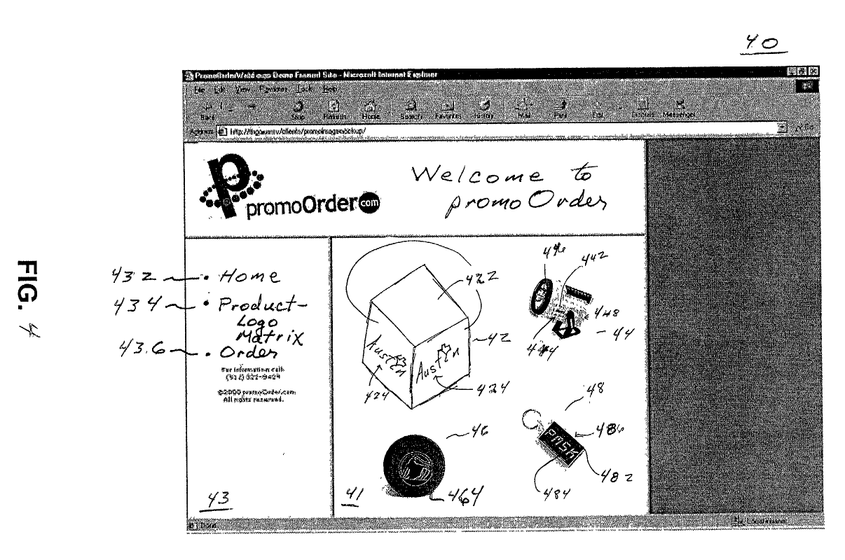

FIG. 4 includes an illustration of a view 40 of images of items (e.g., promotional products) available at an electronic site. In one embodiment, the site can be accessed by the client 102 via the server 142 in order to get information about promotional products available from the distributor. The view 40 can include a navigation bar 43 and a display portion 41. The navigation bar 43 can contain a link to a home page 432, a link to a Product-Logo Matrix page 434, a link to an electronic order form 436, or the like.

The display portion 41 can include composite images of products (items) including a glass cube 42, a work light 44, a stress ball 46, and a key chain 48 that have been previously generated. The glass cube 42 includes several marking areas 422 that generally correspond to each of the sides of the cube. On at least one side of the cube, there is a marking 424. In this specific instance, the marking 424 includes the word “Austin” with the state of Texas used for a dot over the “i” in Austin. Work light 44 can include a marking area 442 and a marking 444 that includes “Hertz”. The marking area 442 is designated by the dashed line on item 44. With the stress ball 46, the entire surface of the ball can be a marking area for a marking 464 that includes an illustration of a mountain within a circle. Key chain 48 has a tag 486 that can include a marking area 482 and a marking 484 that includes “PMSK”.

Note in some of the items as shown in FIG. 4, there may be one marking area as seen in items 42, 44, and 48. These marking areas may be contiguous with one another or they could be spaced apart. For example, in item 42, each of the marking areas contacts a different marking area because the surfaces of the cube can be used for printing. For each of the work light 44 and the key chain 48, another marking area may lie at a corresponding position on a side of the item opposite the side having the marking area shown in FIG. 4. In this example, the marking areas for the work light 44 and the key chain 48 can be spaced apart.

A supplier or other entity that is familiar with details regarding the items may have information regarding location and shape of the marking areas. In other embodiments, nearly anyone, including the user, may be able to define or otherwise provide information regarding the marking area. If a user is to define a marking area, specifications or limits on the size or location of the marking area may be kept in a file within storage device 144 or other location. In many instances, the marking areas can be defined by four comers when viewing the marking area head on. In one embodiment, the marking area can be specified by coordinates of opposite comers, such as the upper left-hand comer and the lower right-hand comer. The coordinates may be in terms of a distance from the top of the item and a distance from the left edge of the item. The area of the marking area can be determined from the coordinates.

The following non-limiting examples are given to illustrate the concepts. The glass cube 42 may have six marking areas 422 that can be each designated by (0.0 cm from left, 0.0 cm from top) as the coordinate for the upper left-hand corner and (6.0 cm from left, 6.0 cm from top) for the coordinate of the bottom right-hand comer. This yields an area of approximately 6.0 cm by 6.0 cm. The six marking areas correspond to the surfaces of the cube and those surfaces are substantially flat. The work light 44 may have marking area coordinates of (2.5 cm from left, 6.0 cm from top) for the upper left-hand comer and (5.5 cm from left, 7.5 cm from top) for the lower right-hand comer. Marking area 442 can have an area of approximately 3.0 cm (5.5 cm−2.5 cm) by 1.5 cm (7.5 cm−6.0 cm) and is substantially flat.

Similar coordinates may be used for the tag 486 of the chain 48, and the marking area 482 can have, for example, dimensions of 3.0 cm by 1.5 cm and be substantially flat. The work light 44 and the key chain 48 may be noted as having another marking area on the opposite side. In the case of the work light 44, the left coordinate for the marking area on the opposite side (not shown) could be expressed as a distance from the end 448 of the work light 44 that is opposite the light bulb assembly 446. The stress ball 46 may be a sphere with a diameter of approximately 3.0 cm, and the marking area may be designated at the surface area of the sphere. Marking limitations may also be given. For example, a marking limitation for the stress ball 46 could be that the marking should not overlap itself, while the key chain 48 may have a marking limitation that the edges between the sides (corresponding to the marking areas) cannot be used for marking.

Skilled artisans can appreciate that the dimensions given are only illustrative and not meant to limit the invention. In other embodiments, coordinates for the marking area may be given in terms of a distance from the right side of the item, a distance from the bottom of the item, radius and angle from a center point of a surface of the item, any combination of these, or the like.

While the visual information in FIG. 4 may give the user good visual information regarding the appearance of and how markings of others may appear on the item, it does not display how a marking desired by the user may appear on the items shown. Because the storage device 144, which is coupled to server 142, may having a database with the images of the items without any markings (i.e., “blanks”) and marking area information (e.g., coordinates, size of the marking area, surface shape, etc.), a user can use an image of his or her marking(s) with the image of the item(s) to create composite images that show how the user's marking may appear on the items.

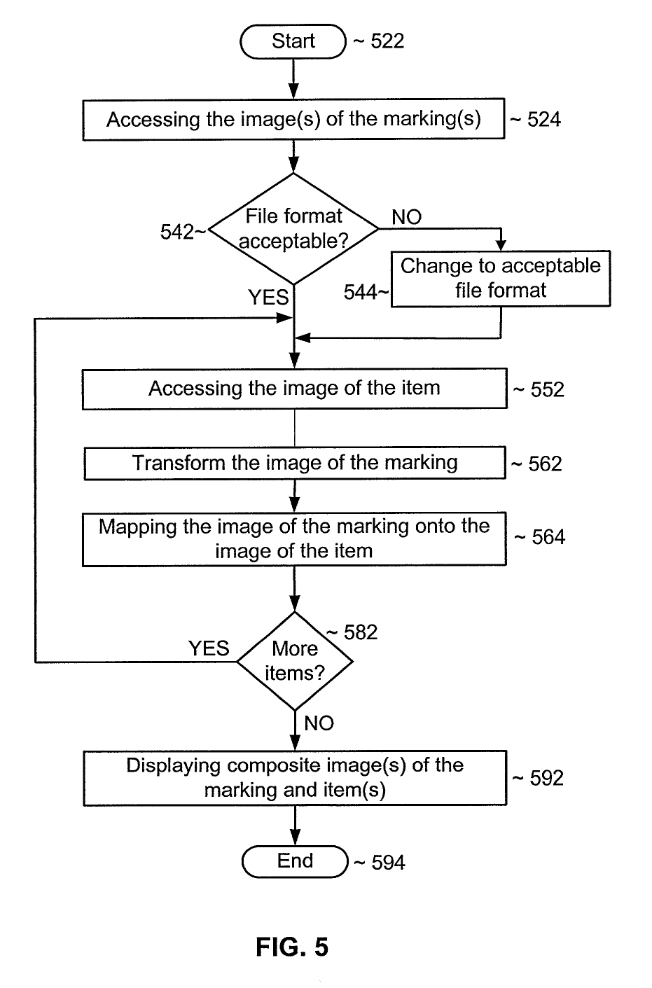

FIG. 5 includes a process flow diagram for automatically placing image(s) of a marking(s) onto image(s) of item(s). The user starts (oval 522) by accessing the image(s) of the marking(s) and the image(s) of the item(s) as shown in block 524. Accessing may be performed by the user at client 102. If the database within storage device 144 does not already have the image(s) of the marking(s), the user may upload a file with the image(s) of the marking(s) to server 142.

Returning to FIG. 5, server 142, which may be used in operating the electronic site, may determine if the file format of the file(s) having the image(s) of the marking(s) are acceptable (diamond 542 in FIG. 5). Many different file formats may be used for the image(s) of the marking(s) including Encapsulated Postscript (EPS), Portable Document Format (PDF), Graphics Interchange Format (GIF), Joint Photographic Experts Group (JPEG), or the like. The quality of reprint of the marking on the item may depend partly on the file format but also may depend to at least a certain degree on the resolution of the image used. The higher the resolution, the more accurate the reproduction of the marking onto the item. The file with the image of the marking may be a vector-based file as suppliers and distributors frequently use these types of files. In other embodiments, a bitmap or other similar image could be used.

The validation graphics file method can be used to determine if the file format is correct. The method may be passed a file name or other identifier for the file having the image of the marking. The method may examine the file name extension and access the file having the image to determine if the file format is correct. For example, a file with the image may be within a Microsoft Word™ file and the file name includes “doc” as the file name extension. Server 142 may determine that this is an unacceptable file format because the resolution of the image may not be sufficient. However, a file with the image may be within a JPEG file and the file name include “jpg” as the file name extension. Server 142 may determine that this is an acceptable file format. Because user's can change file name extensions (e.g., a Microsoft Word™ file can have its name edited to have an extension “jpg”, although its contents are still a Microsoft Word™ file), the method may also examine the contents of the file to confirm that the file has a recognized structure that corresponds to an acceptable file format.

Additionally, the validation method may examine the contents of the file to confirm that the file is a vector-based file if a vector-based file is required. Further, the validation method can be used to determine if the resolution of the image is sufficient.

If the format is not acceptable, the server 142 may try to change the file format to an acceptable file format in block 544. The change may be performed without any human intervention. Otherwise, server 142 may request whether the user wants to convert the file format. Alternatively, if many file formats could be used and the file is already in an acceptable file format, the server 142 may inquire whether the user is willing to have the file format converted to a different file format that is more desired by the server 142. If the user allows the change, the server 142 changes the file format. The validation method may be run again after the file format change to confirm that the file is acceptable. Otherwise, it may not be changed. In another embodiment, the server 142 may specify the file format(s) and refuse any format other than those. If the storage device 144 already has the file with the image of the marking associated with the user or the user's entity, file format conversion is not needed. Therefore, acts 542 and 544 are optional and not required.

After accessing the image(s) of the marking(s) and file formation conversion, if any, the user at client 102 may access the electronic site of the intermediate party at server 142 using the network 12 if this has not yet happened. After accessing the site, the user can proceed with having a composite image(s) generated that can include the marking(s) associated with the user.

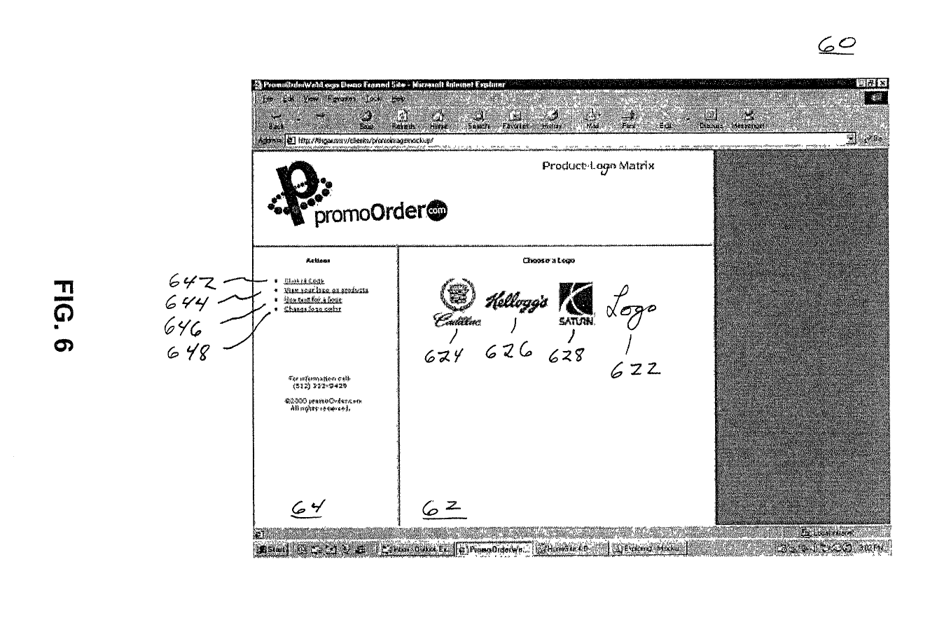

In response to a signal(s) from the user, server 142 can send data for the client 102 to display view 60 in FIG. 6 to the user. The view can include an action portion 62 and a navigation bar 64. The navigation portion can include choosing a logo (marking) 642, viewing the logo on products (items) 644, using text for a logo 646, and changing a logo color 648. If “Choose a Logo” 642 is selected, the action portion 62 can include images of logos 622, 624, 626, and 628 from the Logo Image table 322. The electronic files for the logos may be located within storage device 144. The user can select the image of the marking associated with the user from storage device 144. Alternatively, the user can select an identifier for the user's entity (e.g., the user's company name, initials, or the like) already within storage device 144, wherein the identifier is linked to (associated with) the mark or the like. In one example, user may select logo 622, which is a stylized version of the word “Logo”. In this manner, the server 142 can access an image of a marking and can be instructed what specific marking that the user desires. If the file that includes the image of the marking has not been previously sent from client 102 to any of the servers 122, 142, or 162, the navigation bar 64 may include an option to upload the file (not shown).

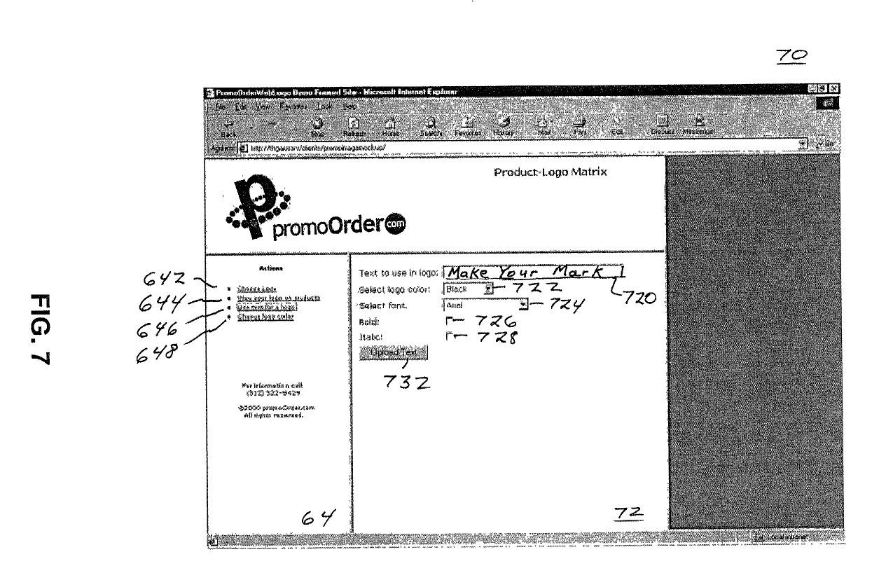

If desired by the user, text can replace or be used in conjunction with the marking. User may select “Use text for a logo” 646. In response to the selection, client 102 can be displayed view 70 as shown in FIG. 7. User, at client 102, may enter text within text box 720. In one example, “Make Your Mark” can be entered by the user. Other words or symbols can be used in the text box 720. Referring to the action portion 72, the user can select color of the text by using the color pull-down menu 722, font by using the font pull-down menu 724, whether the text should be boldfaced by using the bold box 726, and whether the text should be italicized by using the italic box 728. Other options (e.g., underlining proportionality of text, etc.) may be used with portion 72 but are not shown in FIG. 7.

When the user is satisfied with the entries, he or she clicks on the “Upload Text” button 732. Referring to the Logo Image Transform table 324 (in FIG. 3), IsText is set to true, “Make Your Mark” is assigned to TextContents, and the font selected is assigned to TextFont. In one example, the stylized word “Logo” and a tag line of “Make Your Mark” may be used. Alternatively, “Make Your Mark” could have replaced the stylized word “Logo”.

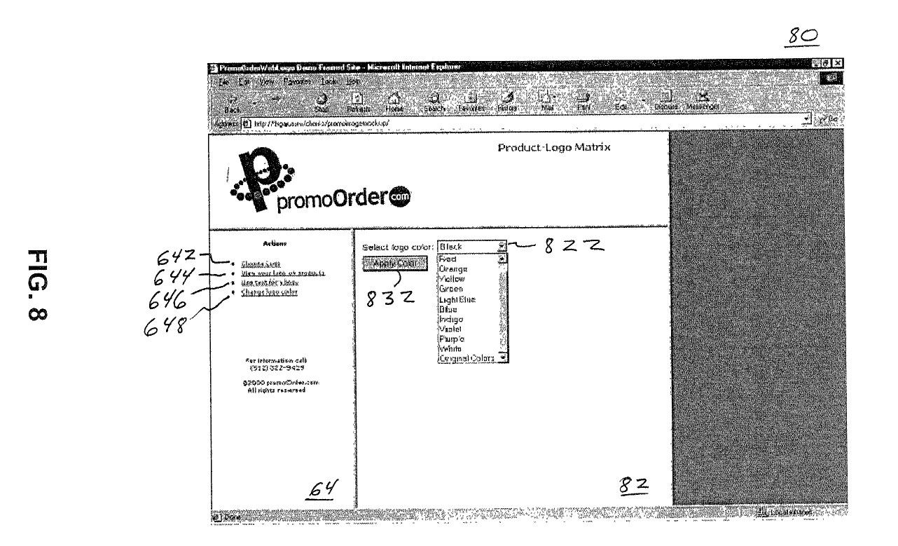

If desired by the user, the color of the marking may be changed. User may select “Change logo color” 648. In response to the selection, client 102 can be displayed view 80 as shown in FIG. 8. Referring to the action portion 82, the user can select color of the logo with the color pull-down menu 822. Note that one of the selections can be to keep the original colors (given a value of “−1” in one embodiment). The program may allow a color substitute for a two-color marking where one of the colors is black (not shown in FIG. 8). When the user is satisfied with the selection, he or she clicks on the “Apply Color” button 832. Referring to FIG. 3, the various attributes color selected is assigned to the ColorID, ColorName, and RGBNumber.

Some markings can include not only the lines of lettering but also a background designation. For example, a trademark of General Motors Corporation includes “GM” within a rectangular blue field. In this case, the letters “GM” and the blue field should be illustrated and not just the “GM” by itself. In this case, the marking would include both the blue field (background portion of the image of the marking) and the line lettering of the “GM”. Therefore, the blue field should not be placed at the furthest background level, but the image of the item (product) should be placed at a lower level (background) compared to the blue field. If the unmarked or background portion of the image of the marking is not to be displayed (blue field not to be displayed), the foreground portion (“GM” lettering) would appear to cover a portion of the image of the item, but the background portion (blue field) would appear to be transparent with respect to the image of the item. Therefore, a part(s) of the image of the item that would otherwise be covered by the background portion of the image of the marking are visible. This “transparent” background designation allows those part or parts of the image of the item to be seen after mapping has been performed.

Although not shown, the user may be given the option to select a background color for the marking. If no data is present or a “0” or “−1” value may be used, the server 142 may understand the lack of data or the “0” or “−1” value to mean that the background of the marking is to be transparent. Alternatively, transparent could a selection that could be made from a pull-down menu. Otherwise, the view would be similar to active portion 82. In still another embodiment, the user may have an option to select levels for the images of the marking (and its different parts) and the item. For the prior example, “GM” may be designated to be at the highest level, the blue field may be designated to be at an at intermediate level, and the item may be designated to be at the lowest level when the three objects and their respective levels are compared.

The method may further include the capability of flagging errors made by users to try to prevent the likelihood of a mistake when making the promotional products. For example, the server 142 may be able to compare a color of the marking and the color of the item and flag a potential color-related issue. This may, in certain circumstances, be up to the user to determine when a certain problem gets to the extent of being a color-related issue. In one example, the marking and item may be substantially the same color. Distinguishing between the marking and the item may be difficult, if not practically impossible.

While some users may not like similar colors for the marking and item, others may actually prefer them. For example, one user may find that a medium blue (wavelength approximately 470 nm) item with a teal (wavelength approximately 490 nm) marking to be acceptable, whereas, a different user may determine that the colors are too close to each other. A program can determine the difference of the wavelengths of at least one color within the marking and at least one color of the item. For example, the minimum difference may be approximately 20 nm for one user and approximately 50 nm for a different user. The minimum difference between colors may also be called the tolerance factor between colors. Other methods can be used for the color comparison (e.g., using the Pantone™ color numbering system, a color system developed by a standards body, or the like) in conjunction with or instead of the wavelength based comparison. The color tolerance factor may be used for the colors of a foreground portion and a background portion of a marking, if desired by the user.

If the color designations meet the minimum color difference guidelines, no error message may be generated. If the guidelines are not met, the composite image may not be generated, a warning may be sent to the client 102, a combination of thereof, or the like. In one embodiment, server 142 may flag a potential color-related issue after comparing the color of the marking and the color of the item. The server may send a warning to the user because the colors of the marking and the item are too similar to each other or are substantially the same. If the user is satisfied, the program may allow the user to receive the composite image and place an order based on the composite image, provided, the user is willing to bear the risk.

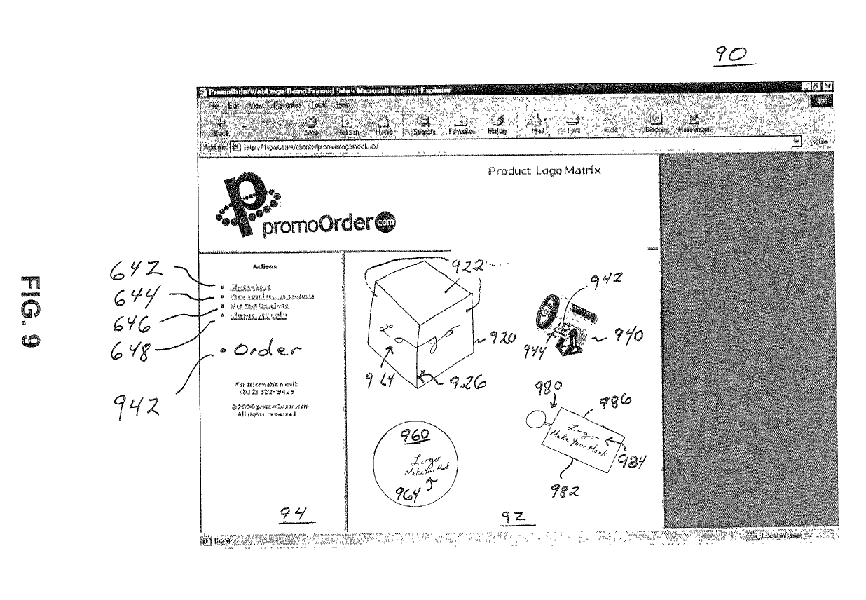

The user may now select “view your logo on products” link 644 to see the composite image(s) using image(s) of marking(s) of the user and images of the items as illustrated in view 90 in FIG. 9. The active portion 92 can include composite images for a glass cube 920, a work light 940, a stress ball 960, and a key chain 980. Before describing features or other characteristics of the composite images, a functional description of the actions performed by server 142, client 102 (and the user), or both in generating composite images will be described.

An image of an item selected by the user at client 102 (or as previously determined by the intermediate party, distributor, or supplier) can be accessed by the server 142 (block 552 in FIG. 5). Referring to FIG. 3, the item may have a ProductID and an associated ProductFile that may include the image of the item and other information related to the item, such as the location(s) dimensions, or geometry of the marking areas as previously described. Alternatively, the information related to the location(s) dimensions and geometry may be kept in a separate file. The server 142 can transform the image of the marking (block 562) so that it better fits within the marking area for the item. The transformation may include sizing (changing the size of the image of the marking), skewing at least a portion of the image of the marking (changing the appearance of the marking such that it appears to be projecting into or out of the image of the item), rotating at least a portion of the image of the marking, and wrapping (changing at least a portion of the image of the marking to correspond to the image of the outer surface of the marking area for the item). Any or all of these acts (or portion(s) of those act(s)) during transformation can be performed without any human intervention.

Sizing of the image of the marking can be performed so that the size of the image of the marking and marking area are closer to each other. In a non-limiting example, the marking can have dimensions of 5.0 cm by 3.0 cm and the marking area can have dimensions of 4.0 cm by 3.0 cm. The server 142 determines that the marking would extend outside the marking area. Therefore, the image of the marking may be reduced in size so that it fits within the marking area.

Although not required, to reduce the effects of distorting the image of the marking, the ratio of the height and width dimensions of the image of the marking can be substantially the same before and after sizing. The sizing reduces the 5.0-cm dimension to 4.0 cm, a 20% reduction. Note that the 3.0-cm dimension of the marking can also be changed, although the 3.0-cm dimension of the marking would not extend outside the corresponding 3.0-cm dimension of the marking area. The change to the 3.0-cm dimension of the marking can be made so that the image of the marking does not appear distorted. Therefore, the 3.0-cm dimension can likewise be reduced by 20% to 2.4 cm. After sizing, the image of the marking may occupy 4.0 cm by 2.4 cm within the 4.0 cm by 3.0-cm marking area. Referring to the Product Logo Transform table 362, 4.0 cm is assigned to WidthPct and 2.4 cm is assigned to HeightPct. If the area of an image of a marking is significantly smaller than an area of the marking area, the image of the marking can be increased to match more closely the marking area.

Special considerations may need to be taken into account when sizing. For example, the stress ball 46 may not have any limitations on the location of where the marking is positioned. However, the image of the marking should not be allowed to wrap around the image of the stress ball 46 such that at least a portion of the image of the marking may appear to overlap itself. The overlapping would most likely occur near edge locations further from the center of the marking of the image of the marking before points of the image of the marking closer to the center. Therefore, the examination at comers of the image of the marking may be the focus if the image has a rectangular shape.

In one example, a stress ball can have a diameter of approximately 6.0 cm (radius is approximate 3.0 cm). Will a 3.0 cm (height) by 5.0 cm (width) marking overlap itself when mapped onto the ball? The analysis is very similar to determining the circumference of the earth at different latitudes. For a cross section of a sphere, all points along the outer surface are one radius away from the center and can be broken down into an x-component of the radius (rₓ) and a y-component of the radius (r_{y}). From geometry, r²=rₓ²+r_{y}². For the marking, approximately 1.5 cm of the marking would like above the “equator” of the sphere and approximately 1.5 cm lie below the “equator”. Substitute 3.0 cm for r (the ball has a diameter of 6.0 cm) and 1.5 cm for r_{y}, and solve for rₓ. In this instance, rₓ is approximately 2.6 cm. The circumference for that “latitude” of the sphere is 2πrₓ or approximately 16.3 cm. Resizing is not needed because 5.0 cm (width of marking) is less than 16.3 cm. Although centimeters were used, other units or even arbitrary units of measure can be used.

If the image of the marking is to be limited to a hemisphere view of the ball, the circumference is halved. Also, if the image of the marking is higher than it is wide, r and rₓ is used to the equation above and solved for r_{y}. From this, the circumference corresponding to r_{y} can be determined. If the image of the marking is larger than desired, then the image of the marking is reduced at least until it fits onto appropriate portion(s) of the image of the ball. Additional constraints may be used, if desired.

The wrapping transformation can be used to adjust a two-dimensional representation of the marking to a three-dimensional surface of the item (e.g., stress ball 860). The item may have a feature including a curved surface, a contour, a comer, an undulating surface, or the like. The data regarding the feature may be included with the marking area information provided by the supplier or other source familiar with details regarding the item as previously described. The image of the marking and the item can each have a grid representation. During at least some of the wrapping, the grid may be electronically bent, twisted, or otherwise changed to conform to an outer surface of the item. Many surfaces of the items will be flat or can be defined by an equation of a curved surface. If the surface is defined by an equation, the shape of the grid is changed to match more closely the equation. After wrapping, if wrapping is needed, the image(s) of the shape(s) of the marking(s) should correspond to the image(s) of the outer surface of the marking area of the item. At least some of the information regarding wrapping may be specified in the RotationDegrees and SkewFactor of the Product Logo Transform table 362.

The image of the marking can be mapped onto the image of the item as shown in block 564 of FIG. 5. Mapping can include acts of positioning, electronically “pasting” the image of the marking onto the image of the item, or the like. The positioning can include an initial alignment (effectively centering the image of the marking with the image of the marking area) and an optional rotation or offset before pasting. At least part of the mapping may be performed using LEADTOOLS™ software by Lead Technology, Inc. of Charlotte, N.C. Any or all of the acts during mapping may be performed without any human intervention. Alternatively, some of the positioning (initial alignment of the image of the marking to the marking area) may be performed automatically and additional positioning may be performed manually.

The mapping may be better understood with a specific, non-limiting example. Many markings and marking areas may have four corners. Two opposite corners of the marking area and the corresponding opposite corners of the image of the marking may be positioned to reduce the sum of the distances between the corners and to keep the distances between corresponding corners approximately equal. In one specific embodiment, the upper left-hand corner of the image of the marking area is positioned near the upper left-hand corner of the marking, and the lower right-hand corner of the image of the marking area is positioned near the lower right-hand corner of the marking. The distance between the two upper left-hand corners and the distance between the two lower right-hand corners should be substantially equal. Generally, mapping can be performed to ensure that the image of the marking lies at least partially or completely within the marking area. When positioning is completed, a location for an upper left-hand comer for the marking area may be assigned to LeftPct and TopPct of the Product Logo Transform table 362.

Before pasting, client 102 or a server 122, 142, or 162 can rotate the image of the marking and the image of the item relative to each other or shift the image of the marking and the image of the item relative to each other. While all the mapping operation can be performed without any human intervention, in an alternative embodiment, the rotating or shifting may be performed as a manual operation by user or another individual. A user may prefer to have a marking rotated to a specified angle, for example, approximately 20 degrees. In another embodiment, the user want to shift the logo off center in a direction to the side, up, down, diagonally, or nearly any variation thereof. The software may allow manipulation as long as the marking stays within the marking area.

At this point, the image of the marking can be electronically “pasted” or mapped onto the image of the item to create a composite image of the item with the marking. The composite image may be saved as an electronic file within storage device 146. Alternatively, the composite image may reside in the RAM of server 142.

In another embodiment, different points, fewer points, or more points could be used in mapping. Typically, server 142 can identify a point(s) on the image of the marking and a corresponding point(s) of the marking area. For example, the center points of the image of the marking and the marking area could be used. In this instance, sever 142 may match the center point of the image of the marking to the center point of the marking area. In another example, if a marking area for an item has an octagonal shape, each comer may have its own point or each side along its midpoint of the side could have a point representing a location that is to be matched to a corresponding location for the image of the marking. Optionally, no points may be used and server 142 may place the image of the marking so that it is centered within the marking area. For example, the software could minimize exposed area of the marking area not covered by the image of the marking and keep portions of exposed areas along opposite sides of the image of the marking substantially equal.

Returning to FIG. 5, the image of the marking has been mapped onto image of the item so that the image of the marking lies within the marking area and forms a composite image of the item with the marking. A decision is made whether more composite images using images of different items and the marking need to be generated as illustrated in diamond 582. If yes, the process returns back to block 552 to generate an additional composite image(s) of the marking and the image(s) of a different item(s). Alternatively, if more than one marking is used, yet another loop (not illustrated) is performed starting at block 524. If there are no more items, the composite image(s) of the marking(s) and the item(s) are then displayed (block 592) after mapping is completed. When displayed, information provided regarding color, text, background color for the marking, if any, is used to determine what may be displayed at client 102. The composite image(s) can be displayed to nearly anyone including the user, the distributor, the supplier, or the like. In one embodiment, the user (at client 102) receives at least one composite image from the intermediate party (server 142). During at least one point in time, the composite images shown in FIG. 9 are displayed simultaneously to the user. Note that the transforming, mapping, and displaying can be performed without any human intervention.

Referring to FIG. 9, view 90 includes active portion 92 that can have an illustration of composite images of the items 920, 940, 960, and 980. Skilled artisans appreciates that composite images for items 920 and 940 correspond to items 42 and 44 where the markings 424 and 444 are replaced by the marking 622 in FIG. 6. All the composite images in view 90 are displayed simultaneously during at least one point in time to the user (client 102). In this specific example, more than one marking is used in the view 90. Although not shown in FIG. 9, names for the items (e.g., “Glass Cube”, “Work Light”, “Stress Ball”, “Key Chain” or the like) could be displayed near each of the items. The names may be stored within ProductName within the Product table 346.

Attention is directed to some of the details of the composite images in view 90. A composite image illustrates a glass cube 920 having many marking areas 922 and a representation of a feature 926. In this example, the feature can include a comer, and marking appears to extend across the representation of the feature. For other items, the feature can include a curved surface, a contour, a comer, an undulating surface, or the like. Generally, features may increase the difficulty in accurately producing the composite image showing the marking over the item. The image of the marking 924 is illustrated as crossing the image of the representation of feature (comer) 926 in the composite image of item 920 to show how the marking logo would appear as if it extended across the feature. For the composite image of the stress ball 960, the image of the marking 964 can be placed virtually anywhere. The composite image of the key chain 980 includes the image of the marking 984 within an image of marking area 982.

Alternatively, the composite images could include images of different items with the image of the same marking or include images of the same item with images of different markings. In one embodiment, the user may select different categories of items as templates for the images of the items. For example, the user may choose the items by category including a product category (trade show products, office products, outdoor products), timing constraints (products that can be shipped within approximately three days or other user defined time limit), cost constraints (products that cost less than approximately US$10 each or other user defined price limit), products provided by a specific supplier or distributor, seasonal products (Christmas, products typically used in the summer or winter, or the like), or nearly any other classification. The names (CategoryName) and identifiers (CategoryID) for the categories may be kept in the Category table 344 or the Product Table 346. The various categories for the items may be part of a pull-down menu (not shown).

If the markings are to be different, the images of the markings can be different in many different forms including color, font, type of marking (e.g., words versus graphic illustrations), or nearly any characteristic. After a first set of composite images, the process ends as illustrated by oval 594 or can be repeated (not shown). Subsequent acts related to ordering item(s) with marking(s) are described later with respect to making an order using the logo.

From the perspective of the user, he or she may perform an act and receives a composite image(s) of a marking and an item from the intermediate party. The act performed by the user may include sending to the intermediate party image(s) of marking(s) associated with the user, selecting image(s) of marking(s) associated with the user, or selecting an identifier for a second entity associated with the user (e.g., the user's employer). Although the user typically can provide the image(s) of the marking(s), the user may not provide the image(s) of the item(s). Because the process may be highly automated, the user may receive the composite image(s) in no more than approximately one minute after performing one of the acts described earlier in this paragraph. Therefore, the transforming, mapping, and displaying described in earlier can be performed in less than approximately one minute.

Unlike the conventional methods, the transforming, mapping, and displaying of the composite images can be performed automatically by a data processing system (client 102, server 122, 142, or 162) without any human intervention. The methods can be extended to perform an auto-populate function that automatically populates a view with composite images of at least one marking and different items when the user accesses the electronic site. In one specific example, a view can be automatically generated by the server 142 with composite images of the user's marking(s) on all the items within a view sent by server 142 and received by client 102. The time that passes during the auto-populate function or between the time a user accesses an image of the marking and receiving a view with composite images may be no longer than approximately one minute. The user may appreciate receiving “customized” composite images in a quick time frame.

In some instances, only an image of a single marking is used by a user during a visit to the electronic site. The image of the marking may be a default marking of the user, the last marking used by the user, or nearly any other marking associated with the user or the user's entity. The server 142 can perform the transforming, mapping, if needed or desired, to generate the composite images from the images of the items and the markings and then display the composite images. Even for numerous composite images, the time needed for transforming, mapping, and displaying the composite images may be no longer than approximately one minute. Note that transforming, mapping, and displaying may be performed without any human intervention. The user does not need to individually “paste” each image of each marking onto each image of each item.

Another capability of the system may be to detect an error by the user and send a notification of the error to allow human intervention to aid the user. Server 142 may flag the site administrator for the electronic site (entity that owns or controls the server for the web site) that a user is having a problem putting a marking onto an item. The problems can arise from a lack of familiarity with a computer, the electronic site, the program for generating the composite images, or the user may be trying to put a marking where it is not allowed. In any of these instances, a message to the site administrator allows an entity to help or aid the user (potential customer) before the he or she leaves due to frustration or dissatisfaction with the system. If desired human intervention on the part of the entity may be used.

While many of the images that are displayed are only a two-dimensional representation of a three-dimensional object, in some embodiments, the client 102 or server 142 may have the capability to allow the user or other human to electronically manipulate the composite image as if the composite image can be moved to different positions in at least three dimensions. In this manner, the user can see how the marking may appear on the item from different angles or vantage points. Again, this option may reduce the likelihood that the user is dissatisfied with the actual item having the user's marking because the user could more thoroughly examine the composite image.

Note that the markings should generally stay within the marking area. However, the user may decide that a marking should extend at least partially outside the marking area. Server 142 may allow the image of the marking to be placed on the image of the item but may flag the user, so that user is aware that there is a greater risk that the marking may not be able to be properly transferred to the item because the marking may be located at least partially within an area that is very difficult or incapable of being marked. Still, a composite image can be generated where at least part of the image of the marking lies within the working area.

The images of the items and markings can be created by the user, the distributor, the intermediate party, the supplier, or another third party. The images could be located at any or all of the storage devices 104, 124, 144, or 164. The ability to access the images may be controlled by different parties. For example, the user may provide an image of a marking to the intermediate party. The intermediate party may only send the image of the marking to the distributor, supplier, or both only if an order for items is placed by the user. The images of the items may be supplied by the distributor or supplier to the intermediate party. The user may have access to some, but not all, the images of items that the distributor, supplier, or intermediate party has by selectively granting access privileges to the user. The Client Product table 342 can be used to determine which image(s) of item(s) that the user may have access. Alternatively, the parties may grant full access privileges to one another for images of the marking(s), images of the item(s), or both sets.

The system can also be configured so that multiple individuals can use one set of files for a particular entity. For example, a company may create a company store that is maintained by a person within a marketing department of the company. Other employees working for the same company may decide that they would like to buy merchandise from that virtual company store. They would like to see how the logo would appear on various shirts that that person is considering buying. To prevent a logo that has been retired from accidentally being used, the system can be configured to give the marketing person access to all logos that have been have or are currently being used by the company. However, only logos approved by the marketing department can be used by an employee in examining composite images of products with the currently approved logos.

The system may also be configured such that when a composite image has been achieved that the user likes, that he or she may be able to email that composite image to another person. For example, the user may send an email or other electronic communication with the composite image to a person who may be making a financial decision on whether or not to buy the promotional products with that logo.

Although not illustrated, the different marking areas within a product can have different markings. For example, the glass cube 920 as illustrated in FIG. 9 may include the marking 622 from FIG. 6, yet on a different side of the glass cube 920, it may only have the marking within the text box 720 in FIG. 7. Therefore, the user can mix and match images of the markings as he or she desires on different marking areas or the item. Alternatively, if a single marking area is relatively large, images of multiple different markings may be placed into that single marking area. Care may be needed to reduce the likelihood of markings from overlapping each other to the extent the user does not desire this. If a user desires the images of the markings to overlap, he or she may need to denote which of the images of the markings should be closest in the foreground, the farthest from the foreground, or at the same level (e.g., red lines from one marking and blue lines from another marking are to merge and form purple lines only where the two overlap).

The descriptions provided above used server 142 to perform much of the work with respect to the generation of composite images. Server 122 of the distributor, server 162 of the supplier, or the client 102, may perform the work. Selecting of images for items and markings may be performed by any or all of the distributor, the supplier, the intermediate party, or any combination thereof instead of or in conjunction with the user.

The user may order at least one of the items with at least one marking by selecting the “order” link 942 in FIG. 9. For the purposes of this example, the user can be ordering one type of item with one marking. However, nearly any number of different types of items with different combinations may be possible. The user, via client 102, can send an order for the item and marking to the server 142. If the client 102 has previously sent a high resolution image of the marking, it may reside within storage device 144. Otherwise, a file with a high resolution image of the marking may be sent with the order.

After the client 102 sends and the server 142 receives the order, the server 142 then sends at least portions of the order information to the servers 122 and 162 of the distributor and supplier, respectively. Part of the information sent from server 142 to server 162 might include a hyperlink having a relatively low resolution image of the marking. Its purpose can be for the supplier to identify whether it has the marking. The reason why the lower resolution image is sent first is so that the Internet or other electronic communicating system transmission time between the server 142 and server 162 is kept relatively lower than if the higher resolution image is sent.

The supplier may review its database of markings within storage device 164 to determine whether it has a file with the corresponding high resolution of the image of the marking. If the supplier determines that it already has the marking, it will not need to do any further file accessing from the server 142 or storage device 144. However, if the supplier determines it does not have the proper electronic file for the markings, the supplier activates the link that it received from the server 142 to obtain an electronic copy of the file with the high-resolution marking from the storage device 144. The electronic file is typically sent by the server 142 and received by the server 162. Similar actions could occur where the distributor (server 122 and storage device 124) replaces the supplier (server 162 and storage device 164).

Note that the higher the resolution of the marking, the more accurate the marking will be on the promotional item. Therefore, it can be advantageous to try to achieve the highest possible resolution of the markings for the supplier to accurately represent the markings on the items. However, transmitting these high resolution images more than necessary can use too much bandwidth of the network. To reduce the transmission burden, the illustration of a marking could be sent in a low resolution, two color, or monochromatic version using one of the file formats previously described. When an order is placed, this other version of the file format can be sent with a link to the higher resolution file of the marking. Typically, the file with the marking that is to be put onto the item has at least one more color than the illustration shown with the link. The file format may be different between the marking to be used for making the promotional products and the marking needed for identification purposes only.

Alternatively, the files may be automatically checked using the control information previously described. If the file name sent by the user matches to a corresponding file name already within the storage device 144, the graphics file with the image of the marking is likely within the storage device 144. If other information regarding the file, for example, a time stamp, does not match the corresponding control information, server 142 may assume that the graphics file with the image has changed and needs to be updated. The client 102 may provide the absolute file name (including the root path) where the file is located. Server 142 may access the information within storage device 104 via the network 12 and client 102 or may send a request to the user at client 102 for the file of the image.

In another set of embodiments, a scanner can be used to generate information for the marking and the identification of the user from a document. In one embodiment, The scanner can be business card scanner, and the document may be a business card. Many business cards include a logo (marking) for a company and contact information for an individual. CardScan 500™ Scanner made by Corex Technologies Corporation of Cambridge, Mass. can be used. The card scanner may be coupled to the client 102 or any of the servers 122, 142, or 162 via a Universal Serial Bus (USB), a parallel port, or other similar connector. In one implementation, a user scans the business card. The card scanner, client 102, or a combination of them can automatically extract typical contact information, including the user's name, job title, company, address, telephone number, facsimile number, email address, or the like, from the business card that is scanned. Intervention by the user or another human is not needed for extracting the information, such as contact information. The information can be saved on storage device 104 or sent to a server 122, 142, or 162 and saved as part of customer contact information within a database that may be part of storage device 124, 144, or 164.

Using the technology described in the preceding paragraph or similar technology, logic can be implemented to separate and automatically extract the logo from the rest of the text to provide an electronic image of the logo. For many business cards, no text lies between the logo and its closest edge of the business card. Although the logo may be located along any side, the logic used for extracting the contact information may be modified to recognize a logo from the text for the contact information (usually a series of lines with text). Considering many business cards may have only the contact information and logo, the logo may be the object that does not correspond to the contact information. If the resolution of the image is insufficient, a higher resolution scanner may be used. In another embodiment, more complex logic may be used to recognize and extract the logo if the business card has any stray markings (pencil or pen marks).

The electronic image may be stored as an electronic file on storage device 104. The extraction of the logo, saving the electronic file, or both can be performed without any human intervention. The user can send the logo to server 122, 142, or 162, or this may be automatically performed using a processor within client 102. Server 122, 142, or 162 can generate a composite image is includes at least part of each of the image of the logo and an image of a promotional product (item) that has been previously described. Numerous composite images can be generated from the one scan if desired. The user can be displayed the composite images.

If the user desires to purchase the promotional product with the logo, at least some of the contact information that was extracted from the business card can be used to populate (automatically enter) information fields (e.g., contact information fields) of an electronic order form. The user may review the information and manually modify part of the information or add other contact information to other contact information fields. For example, job titles of individuals may change before new business cards are issued. In this case, the job title information would be modified. Some business cards do not have electronic mail addresses. The user may add his or her electronic mailing address to the contact information fields. These are just some examples of information that may be modified or added. Clearly other information could be modified or added. The rest of the information for ordering including the promotional product, logo desired, quantity, shipping instructions, account number or purchase order number, or the like can be supplied, and the order can be sent by the user at client 102 to server 122, 142, or 162.

After the information for the order is completed, the user at client 102 can send the order information for a product(s) with marking(s) to the intermediary party at server 142. Server 142 may parse the order information and send some or all of the order information to server 122 and 162. Servers 122 and 162 may receive the same or different information when compared to each other. In an alternative embodiment, the order information could have been sent to server 122 or 162. In one specific embodiment, the user may use the process to order a promotional product with a logo provided by the user.

In another embodiment, a conventional scanner and a company stationery with a letter head could be used. The similar logic described above with respect to the business card scanning process may be used. Most of the stationery may have text for contact information, and the logo may be the only item that is not detected as text. If the stationery has a watermark, the contrast used in scanning may be adjusted so the watermark is not mistaken for the desired logo or other marking that the user desires to capture.

Business card scanning helps to automate the process because most business cards have a company logo and contact information. The order process can be quicker because a significant amount of time would be used to manually enter the data that has been scanned. The logo or other marking can be extracted from the same source having the contact information. Simplifying the order process can increase the likelihood of getting new customers and retaining current customers.

A benefit of embodiments of the present invention allow a very quick creation of a company store by a user without using a significant portion of that person's or that entity's time. A selection of products and a selection of markings can be performed and then designating which marking should be put on which items. In the simplest version, a number of items are selected with a single marking used. The marking can be automatically be transformed, mapped, and displayed as composite images to show how the marking would appear essentially the same way it would appear on the object itself. The user may decide to change colors of the background item to the extent that it can so that it can see which color of items goes best with the logo or which colors would be possible selections with the logo. The user could run a number of test cases to determine his or her preferred combination(s) of items and markings. Many options exist for how to configure the electronic site. The examples given herein have been meant to illustrate just some of the options and not to give an exhaustive listing of all possibilities.

The description above has focussed more on the actions with a user (client 102) and an intermediate party (server 142). The actions of the intermediate party could be performed by the distributor via server 122 or supplier via server 162. The use of the intermediate party is not required. Alternatively, the supplier (server 162 and storage device 164) may interact with the user (client 102) without the distributor or intermediate party. In another embodiment, the intermediate party may work with a plurality of distributors and a plurality of suppliers. In still another embodiment, one entity (e.g., user, distributor, supplier, intermediate party) can perform any or all the acts on a data processing system related to generating the composite images including accessing files, transforming, mapping, and displaying the composite images, and the likes.

Nearly any control or ownership of the entities may be possible. Each of the user, distributor, supplier, and intermediate party can be different entities that do not substantially or significantly control or own one of the other entities (ownership may include no more than approximately 10% of a different entity, or ownership of voting shares in a different entity is no more than approximately 10%). In other embodiments, one of the entities can substantially control or own another one of the other entities (e.g., one entity may be a subsidiary of another entity), or one of the entities may perform the functions at least two of the functions represented by the distributor, supplier, or intermediate party.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method of placing an image of a first marking over an image of a first item comprising:
accessing the image of the first marking and the image of the first item, wherein the image of the first item includes a first marking area; and
mapping the image of the first marking over the image of the first item so that the image of the first marking lies at least partially within the first marking area, wherein mapping includes a first act that is performed without any human intervention, and wherein the first act is selected from a group consisting of:
positioning at least one of the image of the first marking and the image of the first item with respect to each other; and
pasting the image of the first marking and the image of the first item together.

2. The method of claim 1, wherein:
the method further comprises identifying a center point of the image of the first marking and a center point of the first marking area; and
positioning further comprises matching the center point of the image of the first marking to the center point of the first marking area.

3. The method of claim 1, further comprising identifying a first point and a second point of the image of the first marking and a first point and a second point of the first marking area, wherein positioning further comprises:
positioning the first point of the image of the first marking closer to the first point of the first marking area as compared to the second point of the first marking area; and
positioning the second point of the image of the first marking closer to the second point of the first marking area as compared to the first point of the first marking area.

4. The method of claim 1, wherein mapping further comprises a second act selected from a group consisting of:
rotating at least one of the image of the first marking and the image of the first item relative to each other; and
shifting at least one of the image of the first marking and the image of the first item relative to each other.

5. The method of claim 1, wherein:
the image of the first marking includes a foreground portion and a background portion;
mapping includes placing the image of the first marking in a foreground or placing the image of the first item in a background; and
the method further comprises displaying a composite image of the first mark and the first item, wherein:
the foreground portion appears to cover a portion of the first item; and
the background portion appears to be transparent and allows the first item to be seen after the image of the first marking has been mapped onto the image of the first item.

6. The method of claim 1, further comprising comparing a color of the first marking and a color of the first item and flagging a potential color-related issue.

7. The method of claim 1, further comprising displaying a first composite image of the first marking and first item, wherein displaying is performed after mapping.

8. The method of claim 7, further comprising manipulating the first composite image by a human using a data processing system to examine the first composite image in different positions in at least three dimensions.

9. The method of claim 1, wherein the image of the first item has a representation of a feature selected from a group consisting of a curved surface, a contour, a comer, and an undulating surface.

10. The method of claim 9, wherein, within the first composite image, the first marking appears to extend across the representation of the feature.

11. The method of claim 1, further comprising changing a size of the image of the first marking, wherein before and after changing, a ratio of a height to a width of the image of the first marking is substantially the same.

12. The method of claim 1, further comprising:
receiving a file including the image of the first marking;
determining if a first format of the file is acceptable; and
if the first format of the file is not acceptable, changing the file from the first format to a second format, wherein determining and changing are performed without any human intervention.

13. The method of claim 1, wherein the first item includes a promotional product.

14. The method of claim 1, wherein:
accessing includes accessing an image of a second item, wherein the image of the second item includes a second marking area;
mapping includes mapping the image of the first marking over the image of the second item so that image of the first marking lies at least partially within the second marking area; and
the method further comprises displaying a first composite image of the first marking and first item and a second composite image of the first marking and the second item.

15. The method of claim 14, wherein:
accessing includes accessing an image of a second marking and an image of a third item, wherein:
the image of the third item includes a third marking area; and
the second marking is different from the first marking;
mapping includes mapping the image of the second marking over the image of the third item so that image of the second marking lies at least partially within the third marking area; and
displaying further comprises displaying a third composite image of the second marking and the third item.

16. The method of claim 15, wherein displaying is performed such that the first, second, and third composite images are displayed simultaneously during at least one point in time to a user.

17. The method of claim 1, wherein the image of the first marking is provided by a first entity, and the image of the image of the first item is provided by a second entity that is different from the first entity.

18. The method of claim 1, further comprising transforming the image of the first marking after accessing the image of the first marking.

19. A method of placing an image of a first marking over an image of a first item comprising:
accessing the image of the first marking and the image of the first item, wherein the image of the first item includes a first marking area;
transforming the image of the first marking, wherein transforming includes a first act is performed without any human intervention, and wherein the first act is selected from a group consisting of:
changing a size of the image of the first marking;
skewing at least a portion the image of the first marking;
rotating at least a portion of the image of the first marking; and
changing a shape of at least a portion of the image of the first marking, and
mapping the image of the first marking over the image of the first item.

20. The method of claim 19, wherein the first act comprises changing the size the image of the first marking such that:
if the image of the first marking would extend outside the first marking area, reducing the first marking so that the size no larger than the first marking area; or
if the image of the first marking is smaller than the first marking area, increasing the size of the first marking.

21. The method of claim 19, wherein the first act comprises changing the size of the image of the first marking, wherein before and after changing, a ratio of a height to a width of the image of the first marking is substantially the same.

22. The method of claim 19, wherein the first act comprises skewing the at least a portion of the image of the first marking.

23. The method of claim 19, wherein the first act comprises rotating the at least a portion of the image of the first marking.

24. The method of claim 19, wherein the first act comprises changing the shape of the at least a portion of the image of the first marking to correspond to an image of an outer surface of the first marking area.

25. The method of claim 19, further comprising identifying a center point of the image of the first marking and a center point of the first marking area, wherein mapping further comprises matching the center point of the image of the first marking to the center point of the first marking area.

26. The method of claim 19, further comprising identifying a first point and a second point of the image of the first marking and a first point and a second point of the first marking area, wherein mapping further comprises:
positioning the first point of the image of the first marking closer to the first point of the first marking area as compared to the second point of the first marking area; and
positioning the second point of the image of the first marking closer to the second point of the first marking area as compared to the first point of the first marking area.

27. The method of claim 19, wherein mapping further comprises a second an act selected from a group consisting of:
rotating at least one of the image of the first marking and the image of the first item relative to each other; and
shifting at least one of the image of the first marking and the image of the first item relative to each other.

28. The method of claim 19, wherein:
the image of the first marking includes a foreground portion and a background portion;
mapping further comprises placing the image of the first marking in a foreground or placing the image of the first item in a background; and
the method further comprises displaying a composite image of the first mark and the first item, wherein:
the foreground portion appears to cover a portion of the first item; and
the background portion appears to be transparent and allows the first item to be seen after the image of the first marking has been mapped over the image of the first item.

29. The method of claim 19, further comprising comparing a color of the first marking and a color of the first item and flagging a potential color-related issue.

30. The method of claim 19, further comprising displaying a first composite image of the first marking and first item, wherein displaying is performed after mapping.

31. The method of claim 30, further comprising manipulating the first composite image by a human using a data processing system to examine the first composite image in different positions in at least three dimensions.

32. The method of claim 19, wherein the image of the first item has a representation of a feature selected from a group consisting of a curved surface, a contour, a comer, and an undulating surface.

33. The method of claim 32, wherein, within the first composite image, the first marking appears to extend across the representation of the feature.

34. The method of claim 19, further comprising:
receiving a file including the image of the first marking;
determining if a first format of the file is acceptable; and
if the first format of the file is not acceptable, changing the file from the first format to a second format, wherein determining and changing are performed without any human intervention.

35. The method of claim 19, wherein the first item includes a promotional product.

36. The method of claim 19, wherein:
accessing includes accessing an image of a second item, wherein the image of the second item includes a second marking area;
mapping includes mapping the image of the first marking over the image of the second item so that image of the first marking lies at partially within the second marking area; and
the method further comprises displaying a first composite image of the first marking and first item and a second composite image of the first marking and the second item.

37. The method of claim 36, wherein:
accessing includes accessing an image of a second marking and an image of a third item, wherein:
the image of the third item includes a third marking area; and
the second marking is different from the first marking;
mapping includes mapping the image of the second marking over the image of the third item so that image of the second marking lies at least partially within the third marking area; and
displaying further comprises displaying a third composite image of the second marking and the third item.

38. The method of claim 37, wherein displaying is performed such that the first, second, and third composite images are displayed simultaneously during at least one point in time to a user.

39. The method of claim 19, wherein the image of the first marking is provided by a first entity, and the image of the image of the first item is provided by a second entity that is different from the first entity.

40. A method for a user to automatically receive a composite image while at an electronic site comprising:
performing a first act that is performed by the user and wherein the first act is selected from a group consisting of:
sending an image of a marking associated with the user to a first entity;
selecting the image of the marking associated with the user; and
selecting an identifier for a second entity associated with the user, wherein the identifier is associated with the image; and
receiving the composite image by the user from the first entity, wherein: receiving is performed after the first act; and
the composite image includes the marking and of an item.

41. The method of claim 40, firther comprises selecting the image of the item, wherein this act is performed by the user.

42. The method of claim 40, wherein the user does not perform a second act of providing the image of the item.

43. The method of claim 40, wherein no more than approximately one minute passes between performing the first act and receiving the composite image.

44. The method of claim 40, wherein:
the marking is a single marking;
the item includes a plurality of different items;
the composite image includes a plurality of composite images; and
each composite image of the plurality of composite images of the single marking and one of the different items.

45. The method of claim 44, wherein the method is performed as an auto-populate function that takes no more than approximately one minute to complete.

46. A method of placing an image of a marking over an image of an item comprising:
scanning a document using a scanner;
automatically extracting the image of the marking and at least some contact information from the document;
automatically placing the image of the marking over the image of the item to create a composite image;
displaying the composite image to a user; and
automatically entering the at least some information into an information field.

47. The method of claim 46, further comprising:
reviewing the at least some contact information in the contact field; and
performing an act selected from a group consisting of: modifying part of the at least some information; and adding other information to another information field.

48. The method of claim 47, further comprising ordering the item with the marking, wherein at least some of an ordering information includes at least part of the at least some information.

49. The method of claim 46, further comprising ordering the item with the marking, wherein the item is a promotional product and the marking is a logo of a company.

50. The method of claim 46, further comprising saving an electronic file of the image of the marking and sending the electronic file to a server.

51. The method of claim 46, wherein:
the document is a business card; and
the scanner is a business card scanner.

52. A data processing system readable storage medium having code embodied therein, the code including instructions executable by a data processing system, wherein the instructions are configured to cause the data processing system to perform a method of automatically placing an image of a first marking over an image of a first item, wherein the method comprises:
accessing the image of the first marking and the image of the first item, wherein the image of the first item includes a first marking area;
mapping the image of the first marking over the image of the first item so that the image of the first marking lies within the first marking area, wherein mapping includes a first act that is performed without any human intervention, and wherein the first act is selected from a group consisting of:
positioning at least one of the image of the first marking and the image of the first item with respect to each other; and
pasting the image of the first marking and the image of the first item together.

53. The data processing system readable storage medium of claim 52, wherein:
the method further comprises identifying a center point of the image of the first marking and a center point of the first marking area; and
positioning further comprises matching the center point of the image of the first marking to the center point of the first marking area.

54. The data processing system readable storage medium of claim 52, wherein:
the method further comprises identifying a first point and a second point of the image of the first marking and a first point and the second point of the first marking area; and
positioning further comprises:
positioning the first point of the image of the first marking closer to the first point of the first marking area as compared to the second point of the first marking area; and
positioning the second point of the image of the first marking closer to the second point of the first marking area as compared to the first point of the first marking area.

55. The data processing system readable storage medium of claim 52, wherein mapping further comprises a second act selected from a group consisting of:
rotating at least one of the image of the first marking and the image of the first item relative to each other; and
shifting at least one of the image of the first marking and the image of the first item relative to each other.

56. The data processing system readable storage medium of claim 52, wherein:
the image of the first marking includes a foreground portion and a background portion;
mapping further comprises placing the image of the first marking in a foreground or placing the image of the first item in a background; and
the method further comprises displaying a composite image of the first marking and the first item, wherein:
the foreground portion appears to cover a portion of the first item; and
the background portion appears to be transparent and allows the first item to be seen after the image of the first marking has been mapped onto the image of the first item.

57. The data processing system readable storage medium of claim 52, wherein the method further comprises comparing a color of the first marking and a color of the first item and flagging a potential color-related issue.

58. The data processing system readable storage medium of claim 52, wherein the method further comprises displaying a first composite image of the first marking and first item, wherein displaying is performed after mapping.

59. The data processing system readable storage medium of claim 52, wherein the image of the first item has a representation of a feature selected from a group consisting of a curved surface, a contour, a comer, and an undulating surface.

60. The data processing system readable storage medium of claim 59, wherein, within the first composite image, the first marking appears to extend across the representation of the feature.

61. The data processing system readable storage medium of claim 52, wherein the method further comprises changing a size of the image of the first marking, wherein before and after changing, a ratio of a height to a width of the image of the first marking is substantially the same.

62. The data processing system readable storage medium of claim 52, wherein the method further comprises:
receiving a file including the image of the first marking;
determining if a first format of the file is acceptable; and
if the first format is not acceptable, changing the file from the first format to a second format, wherein determining and changing are performed without any human intervention.

63. The data processing system readable storage medium of claim 52, wherein the image of the first item includes an image of a promotional product.

64. The data processing system readable storage medium of claim 52, wherein:
accessing includes accessing an image of a second item, wherein the image of the second item includes a second marking area;
mapping includes mapping the image of the first marking over the image of the second item so that image of the first marking lies within the second marking area; and
the method further comprises displaying a first composite image of the first marking and first item and a second composite image of the first marking and the second item.

65. The data processing system readable storage medium of claim 64, wherein:
accessing includes accessing an image of a second marking and an image of a third item, wherein:
the image of the third item includes a third marking area; and
the second marking is different from the first marking;
mapping includes mapping the image of the second marking over the image of the third item so that image of the second marking lies at least partially within the third marking area; and
displaying further comprises displaying a third composite image of the second marking and the third item.

66. The data processing system readable storage medium of claim 65, wherein displaying is performed such that the first, second, and third composite images are displayed simultaneously during at least one point in time to a user.

67. The data processing system readable storage medium of claim 52, wherein the method further comprises transforming the image of the first marking after accessing the image of the first marking.

68. A data processing system readable storage medium having code embodied therein, the code including instructions executable by a data processing system, wherein the instructions are configured to cause the data processing system to perform a method of automatically placing an image of a first marking over an image of a first item, wherein the method comprises:
accessing the image of the first marking and the image of the first item, wherein the image of the first item includes a first marking area;
transforming the image of the first marking, wherein transforming includes a first act is performed without any human intervention, and wherein the first act is selected from a group consisting of:
changing a size of the image of the first marking;
skewing at least a portion the image of the first marking;
rotating at least a portion of the image of the first marking; and
changing a shape of at least a portion of the image of the first marking; and
mapping the image of the first marking over the image of the first item.

69. The data processing system readable storage medium of claim 68, wherein the first act comprises changing the size the image of the first marking such that:
if the image of the first marking would extend outside the first marking area, reducing the first marking so that the size no larger than the first marking area; or
if the image of the first marking is smaller than the first marking area, increasing the size of the first marking.

70. The data processing system readable storage medium of claim 68, wherein the first act further comprises changing the size the image of the first marking, wherein before and after changing, a ratio of a height to a width of the image of the first marking is substantially the same.

71. The data processing system readable storage medium of claim 68, wherein the first act comprises skewing the at least a portion of the image of the first marking.

72. The data processing system readable storage medium of claim 68, wherein the first act comprises rotating at least one of the image of the first marking and the image of the first item relative to each other.

73. The data processing system readable storage medium of claim 68, wherein the first act comprises changing the shape of the at least a portion of the image of the first marking to correspond to an image of an outer surface of the first marking area.

74. The data processing system readable storage medium of claim 68, wherein:
the method further comprises identifying a center point of the image of the first marking and a center point of the first marking area; and
mapping further comprises matching the center point of the image of the first marking to the center point of the first marking area.

75. The data processing system readable storage medium of claim 68, wherein:
the method further comprises identifying a first point and a second point of the image of the first marking and a first point and a second point of the first marking area; and
mapping further comprises:
positioning the first point of the image of the first marking closer to the first point of the first marking area as compared to the second point of the first marking area; and
positioning the second point of the image of the first marking closer to the second point of the first marking area as compared to the first point of the first marking area.

76. The data processing system readable storage medium of claim 68, wherein mapping further comprises shifting at least one of the image of the first marking and the image of the first item relative to each other.

77. The data processing system readable storage medium of claim 68, wherein:
the image of the first marking includes a foreground portion and a background portion;
mapping further comprises placing the image of the first marking in a foreground or placing the image of the first item in a background; and
the method further comprises displaying a composite image of the first mark and the first item, wherein:
the foreground portion appears to cover a portion of the first item; and
the background portion appears to be transparent and allows the first item to be seen after the image of the first marking has been mapped over the image of the first item.

78. The data processing system readable storage medium of claim 68, the method further comprises comparing a color of the first marking and a color of the is first item and flagging a potential color-related issue.

79. The data processing system readable storage medium of claim 68, the method further comprises displaying a first composite image of the first marking and first item, wherein displaying is performed after mapping.

80. The data processing system readable storage medium of claim 68, wherein the image of the first item has a representation of a feature selected from a group consisting of a curved surface, a contour, a comer, and an undulating surface.

81. The data processing system readable storage medium of claim 80, wherein, within the first composite image, the first marking appears to extend across the representation of the feature.

82. The data processing system readable storage medium of claim 68, wherein the method further comprises:
receiving a file including the image of the first marking;
determining if a first format of the file is acceptable; and
if the first format is not acceptable, changing the file from the first format to a second format, wherein determining and changing are performed without any human intervention.

83. The data processing system readable storage medium of claim 68, wherein the first item includes a promotional product.

84. The data processing system readable storage medium of claim 68, wherein:
accessing includes accessing an image of a second item, wherein the image of the second item includes a second marking area;
mapping includes mapping the image of the first marking over the image of the second item so that image of the first marking lies at least partially within the second marking area; and
the method further comprises displaying a first composite image of the first marking and first item and a second composite image of the first marking and the second item.

85. The data processing system readable storage medium of claim 84, wherein:
accessing includes accessing an image of a second marking and an image of a third item, wherein:
the image of the third item includes a third marking area; and
the second marking is different from the first marking;
mapping includes mapping the image of the second marking onto the image of the third item so that image of the second marking lies within the third marking area; and
displaying further comprises displaying a third composite image of the second marking and the third item.

86. The data processing system readable storage medium of claim 85, wherein displaying is performed such that the first, second, and third composite images are displayed simultaneously during at least one point in time to a user.
